(19) United States
(12) Patent Application Publication
(10) Pub. No.: US 2023/0245230 A1
(43) Pub. Date: Aug. 3, 2023

(54) SYSTEM AND METHOD FOR GENERATING AND CONTROLLING CELEBRITY INVESTMENT STOCK CURRENCY

(71) Applicant: David W. Johnson, III, New Orleans, LA (US)

(72) Inventor: David W. Johnson, III, New Orleans, LA (US)

(21) Appl. No.: 17/589,998

(22) Filed: Feb. 1, 2022

(51) Int. Cl. G06Q 40/06; G06Q 40/04

(52) U.S. Cl. CPC G06Q 40/06; G06Q 40/04

(57) ABSTRACT

A system for implementing a celebrity stock currency investment and payment server creates a plurality of user accounts based on user information of a plurality of users. Each of a first set of user accounts of the plurality of user accounts has at least one stock, and each user account of the first set of user accounts is associated with a popularity level. The server periodically receives specific user like data corresponding to the first set of user accounts from a plurality of remote data sources and adjusts the popularity level based on the specific user like data. Further, the server adjusts a celebrity stock currency value of the at least one celebrity stock currency based on the adjusted popularity level and outputs the adjusted celebrity stock currency value.

### BACKGROUND OF THE INVENTION

### Field of the Invention

The present disclosure is related to financial technology, and more particularly related to a system and method for generating and controlling investment stock currency.

### Description of the Related Art

Recent advancements in financial technology have led to development of various devices and platforms for managing finance of individuals and different organizations. These platforms facilitate individuals to invest their money in different ways such as stock investment, fixed deposit investment, and the like. However, for the purpose of the stock investment, an individual either needs to have comprehensive knowledge about the desired stock or to rely on information available on existing financial/investment platforms. Further, an individual is also required to have multiple accounts or multiple server access to complete monetary transactions in such type of investment. Furthermore, individuals face challenges in buying/selling stocks due to lack of sufficient knowledge of current market or due to lack of access of user friendly platforms. Also, the existing platforms do not have provisions to create stocks for individuals.

Accordingly, there is a need of an investment system that facilitates an alternative financial investment system to thereby provide a greater level of control and ease of use for users that are otherwise unable to invest in a typical investment system.

As disclosed in this application, the inventor has discovered novel and unique systems and methods for generation and control of new currency for financial investments, which exhibit superlative properties without being dependent on comprehensive knowledge about companies' financial earnings and revenues.

Embodiments of the present invention provide for devices and methods disclosed herein and as defined in the annexed claims which provide for improved financial investments in in new currencies in order to efficiently invest one's money, in a safe and convenient manner, for people's financial investment and control of such investment, and for people's enjoyment.

### SUMMARY OF THE INVENTION

Accordingly, it is an objective of some embodiments to provide a unique investment system and method enabling users to create, sell, and buy stocks while generating and controlling currency of the stocks.

To that end, in some embodiments of the present disclosure, a system comprising a celebrity stock currency investment and payment server is disclosed. The celebrity stock currency investment and payment server comprises a celebrity stock currency database. The celebrity stock currency investment and payment server includes a celebrity analyzer configured to receive like data corresponding to a plurality of user accounts, analyze the like data, extract popularity content from the like data, and identify a like based instruction within the extracted like data.

The celebrity stock currency investment and payment server comprises a celebrity stock currency valuation engine configured for like data based comparison and authentication. The celebrity stock currency investment and payment server further comprises a memory configured to store computer-executable instructions and at least one processor coupled to the celebrity stock currency database, the celebrity analyzer, and the celebrity stock currency valuation engine.

In a preferred embodiment, the at least one processor is further configured to execute the computer-executable instructions to: create the plurality of user accounts based on user information of a respective user of the plurality of users, where each of a first set of user accounts of the plurality of user accounts has at least one stock, and each user account of the first set of user accounts is associated with a popularity level of each of a first set of users of the plurality of users.

In one embodiment, the system periodically receives specific user like data corresponding to the first set of user accounts from a plurality of remote data sources.

The system adjusts the popularity level associated with each respective user of the first set of user accounts based on the specific user like data corresponding to each respective user of the first set of user accounts.

In a preferred embodiment, the system adjusts a celebrity stock currency value of the at least one celebrity stock currency of each of the first set of user accounts based on the adjusted popularity level corresponding to each respective user account of the first set of user accounts.

Preferably, the at least one processor is further configured to output the adjusted celebrity stock currency value of the at least one stock of each respective user account of the first set of user accounts.

In additional system embodiments, the at least one processor is further configured to categorize the plurality of user accounts. Preferably, the plurality of user accounts are be categorized into the first set of user accounts and a second set of user accounts based on the user information of the plurality of users.

In some additional embodiments, the at least one processor is further configured to receive a first user input, via a first user interface, from at least one of the second set of user accounts of the plurality of user accounts. Further, preferably, the first user input corresponds to purchase of the at least one stock corresponding to at least one user account of the first set of user accounts.

In yet another embodiment, the at least one processor is further configured to execute a plurality of transaction processes. Preferably, the plurality of transaction processes are based on the reception of the first user input.

In additional embodiments, the at least one processor is further configured to receive a second user input, via a second user interface, from at least one user account of the first set of user accounts. The second user input preferably corresponds to permission to the purchase of the at least one stock corresponding to at least one user account of the first set of user accounts.

In additional embodiments, the at least one processor is further configured to execute a plurality of transaction processes based on the reception of the second user input.

In additional embodiments, the system comprises a first remote data source of the plurality of remote data sources is different from a second remote data source of the plurality of remote data sources.

In additional embodiments, the at least one processor is further configured to:

transmit an account request to each of a plurality of user devices of the plurality of users. Further, the account request corresponds to a request to create a user account to at least one of purchase or sell the at least one stock. The system is further configured to receive acceptance information from the plurality of user devices based on the transmission of the account request; and create the plurality of user accounts based on the received acceptance information.

In additional embodiments, the at least one processor is further configured to generate a temporal information associated with the stock value of the at least one stock of each of the first set of user accounts, where the temporal information is generated based on a record of the stock value of the at least one stock with respect to time; and control a display device to display the temporal information.

In another embodiment, each of the first set of user accounts includes profile information associated with a respective user of the first set of users. The at least one processor is further configured to: dynamically update the profile information associated with each of the first set of user accounts based on the adjusted popularity level of a respective user account of the first set of user accounts. Also, the at least one processor is configured to control a display device to display the adjusted stock value of the at least one stock of each of the first set of user accounts and the updated profile information associated with each of the first set of user accounts.

In yet another embodiment of the present disclosure, a method for implementing a celebrity stock currency based investment and payment system is disclosed. The method comprises creating a plurality of user accounts on a cloud server network device with one or more processors on a cloud communication network, where the plurality of user accounts are based on user information of a respective user of a plurality of users, where each of a first set of user accounts of the plurality of user accounts has at least one stock, and each user account of the first set of user accounts is associated with a popularity level of each of a first set of users of the plurality of users. The method further comprises periodically receiving specific user like data corresponding to the first set of user accounts from a plurality of remote data sources; adjusting the popularity level associated with each respective user of the first set of user accounts based on the specific user like data corresponding to each respective user of the first set of user accounts; adjusting a celebrity stock currency value of the at least one celebrity stock currency of the at least one stock of each of the first set of the user accounts based on the adjusted popularity level corresponding to each respective user account of the first set of user accounts; and outputting the adjusted celebrity stock currency value of the at least one stock of each respective user account of the first set of user accounts.

In yet another embodiment of the present disclosure, a computer program product comprising a non-transitory computer readable medium having stored thereon computer executable instructions is provided. The computer executable instructions, when executed by at least one processor, cause the at least one processor to execute operations, where the operations comprising: creating a plurality of user accounts based on user information of a respective user of a plurality of users, where each of a first set of user accounts of the plurality of user accounts has at least one stock, and each user account of the first set of user accounts is associated with a popularity level of each of a first set of users of the plurality of users; periodically receiving specific user like data corresponding to the first set of user accounts from a plurality of remote data sources; adjusting the popularity level associated with each respective user of the first set of user accounts based on the specific user like data corresponding to each respective user of the first set of user accounts; adjusting a celebrity stock currency value of the at least one celebrity stock currency of the at least one stock of each of the first set of the user accounts based on the adjusted popularity level corresponding to each respective user account of the first set of user accounts; and outputting the adjusted celebrity stock currency value of the at least one stock of each respective user account of the first set of user accounts.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the present disclosure in general terms, reference will now be made to the accompanying drawings, which are not necessarily drawn to scale, and wherein:

FIG. 1 illustrates a network environment diagram of a system, in accordance with embodiments of the invention;

FIG. 2 illustrates a block diagram of a server of the system, in accordance with embodiments of the invention;

FIG. 3 illustrates a first plurality of user interfaces of an exemplary user device of the system, in accordance with embodiments of the invention;

FIG. 4 illustrates a second plurality of user interfaces of the exemplary user device of the system, in accordance with embodiments of the invention; and

FIG. 5 illustrates a flow diagram of operations of the system, in accordance with embodiments of the invention.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Embodiments of the present disclosure will now be described more fully hereinafter with reference to the accompanying drawings, in which some, but not all, embodiments of the present disclosure are shown. Indeed, various embodiments of the present disclosure is embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ preferably refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus (or a system) to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

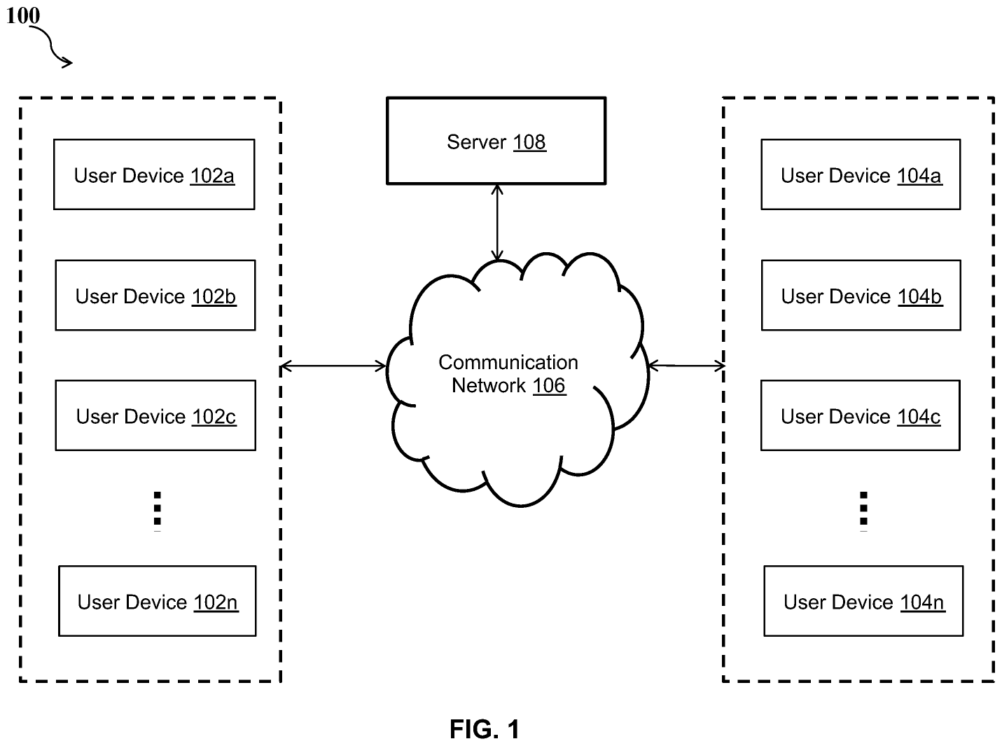

FIG. 1 illustrates a network environment diagram of a system 100, in accordance with embodiments of the present disclosure. The system 100 comprises a first set of user devices 102a, 102b, . . . 102n, a second set of user devices 104a, 104b, . . . 104n, a communication network 106, and a server 108. The first set of user devices 102a, 102b, . . . 102n, the second set of user devices 104a, 104b, . . . 104n, and the server 108 is communicatively coupled with each other via the communication network 106.

Each user device of the first set of user devices 102a, 102b, . . . 102n and the second set of the user devices 104a, 104b, . . . 104n preferably comprises suitable logic, circuitry, and interfaces that are preferably programmed to execute various operations in the system 100 such as creating user accounts, buying/selling stocks, outputting notifications, and the like. The examples of each of the first set of user devices 102, 102b, . . . 102n and the second set of user devices 104a, 104b, . . . 104n include, but are not limited to, a mobile phone, a portable computer, a laptop, a tablet, a personal digital assistant (PDA), and the like.

The communication network 106 comprises suitable logic, circuitry, and interfaces to establish communication among the first set of user devices 102a, 102b, . . . 102n, the second set of user devices 104a, 104b, . . . 104n, and the server 108. In some embodiments, data transferred via the communication network 106 is in the form of signals, which are preferably electronic, electromagnetic, radio, or other types of signals. To that end, the communication network 106 is wired, wireless, or any combination of wired and wireless communication networks, such as cellular, Wi-Fi, internet, local area networks, or the like. In one embodiment, the communication network 106 includes one or more networks such as a data network, a wireless network, a telephony network, or any combination thereof. It is proposed that the data network preferably be any local area network (LAN), wide area network (WAN), a wireless local area network (WLAN), a system area network (SAN), a public data network (e.g., the internet), short range wireless network, or any other suitable packet-switched network, such as a commercially owned, proprietary packet-switched network, e.g., a proprietary cable or fiber-optic network, and the like, or any combination thereof.

In addition, the wireless network is, for example, a cellular network and preferably employs various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), long term evolution (LTE) networks (for e.g. LTE-Advanced Pro), 5G New Radio networks, code division multiple access (CDMA), wideband code division multiple access (WCDMA), wireless fidelity (Wi-Fi), wireless LAN (WLAN), Bluetooth, Internet Protocol (IP) , satellite, mobile ad-hoc network (MANET), and the like, or any combination thereof.

The server 108 comprises suitable logic, circuitry, and interfaces to execute various operations such as processing the data obtained from the first set of user devices (102a, 102b . . . 102n) and the second set of user devices (104a, 104b . . . 104n) via the communication network 106, creating a plurality of user accounts, analysing data received from a plurality of different remote data sources, and controlling different operations based on a result of the analysis of the data.

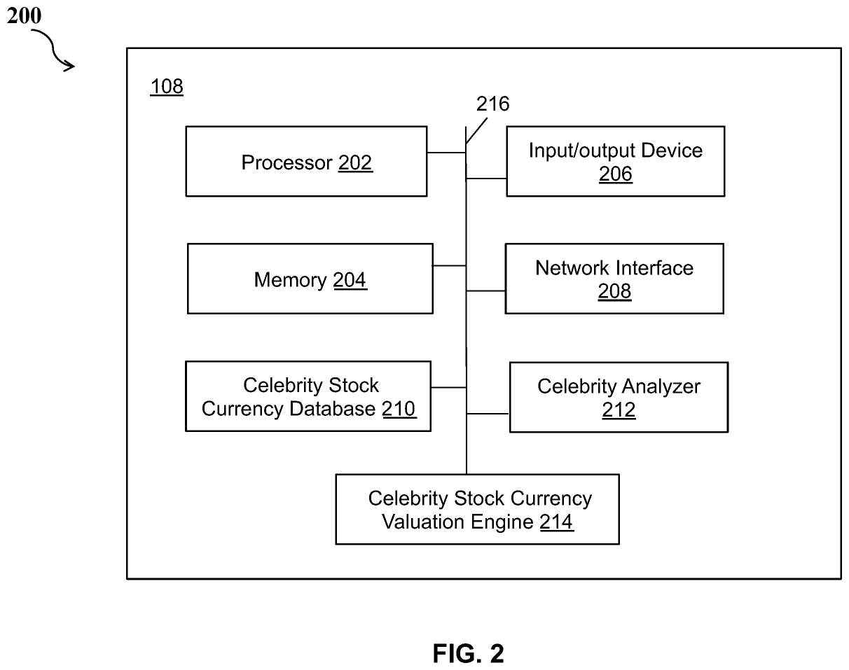

The server 108 is preferably a celebrity stock currency investment and payment server 108, which is programmed and configured to execute the different operations in order to generate celebrity stocks and their currency, control the currency of the stocks, and generate insights for the individuals who buys the stocks for investment. As can be understood by the disclosure herein, the server creates a celebrity stock currency. In some embodiments, the server 108 is a cloud server or a distributed computing system. Elements of the server 108 are described further, in detail, with reference to description of FIG. 2.

Some embodiments disclosed herein are based on inventor's realization that conventional stocks of organizations, corporates, and the like are volatile, which affects investments of individuals. This demotivates individuals in investing into conventional stocks. The individuals always prefer to invest into schemes which ensure profits in future. However, the existing investment schemes do not ensure profits in the future. Also, some embodiments are based on a further realization that individuals are required to know the trends of the market on regular basis in order to decide whether to sell and/or buy stocks. This becomes challenging for them as they may not be interested in the business and technical details of the organisations/corporates. Furthermore, the existing investment platforms have complexities in creating and launching new stocks into the market. The present disclosure discloses a novel system 100 which addresses and overcomes aforementioned problems with existing conventional investment platforms and currencies.

To that end, some embodiments disclosed herein are based on inventor's realization that people tend to follow famous people who are celebrities such as movie actors, sportsmen, singers, popstars, politicians, and the like. Also, growth of the celebrities is more promising than organizations/corporates.

Accordingly, the present disclosure discloses a system 100 which includes the server 108 as the celebrity stock currency investment and payment server 108. In particular, the server 108 provides a platform to create stocks of individuals (e.g., celebrities) based on their popularity. Also, the server 108 determines a popularity level of an individual based on a plurality of parameters such as a number of followers on different social media accounts, a number of posts on different social media accounts, estimated income, and the like.

The server 108 compares the plurality of parameters with threshold values to determine the popularity level. The individuals can create user accounts based on their profile information, and the server 108 associates the determined popularity level and a stock having a specific stock currency value to each user account. Preferably, the server 108 controls the stock currency value of the stocks of the individuals based on a change in their respective popularity.

To that end, the server 108 determines current popularity of the individuals based on a plurality of parameters such as a number of followers on social media accounts, number of likes on posts on social media accounts, upcoming projects and their valuation, a number of posts on the social media accounts, a growth rate of popularity, and the like. Accordingly, the stock value is adjusted based on the change in the popularity. Therefore, an individual who is a celebrity can create a stock without performing complex operations.

More specifically, the server 108 creates a plurality of user accounts based on user information of a respective user of a plurality of users, where a first set of users of the plurality of users is associated with a respective user device of the first set of user devices 102a, 102b, . . . 102n and a second set of users of the plurality of users is associated with a respective user device of the second set of user devices 104a, 104b, . . . 104n. The server 108 categorises the plurality of user accounts into a first set of user accounts and a second set of user accounts based on the user information of the plurality of users. The user information preferably includes name, age, occupation, estimated income, a number of followers on different social media platforms, like data, and the like. For instance, the server 108 categorises the plurality of users in two categories such as a celebrity category and a non-celebrity category. In an example embodiment, the first set of users corresponds to users who are celebrities, and the second set of users corresponds to users who are non-celebrities. Further, each user account of the first set of user accounts is associated with a popularity level of each corresponding user of the first set of users.

After the creation of the first set of user accounts, the server 108 associates one or more stocks to each user account of the first set of user accounts. In some cases, such stocks are also called as celebrity stocks. Each stock is associated with a stock currency value (also called as celebrity stock currency value) which is a dynamic value. The server 108 assigns a specific stock currency value to each user of the first set of users based on their popularity level at a time of the creation of a respective user account. Such popularity level is determined by the server 108 based on the user information. Each user of the second set of users buys stocks of the first set of users (i.e., the celebrities).

In some embodiments, the user information includes like data of the first set of users on different social media accounts. The server 108 receives such like data associated with the first set of user accounts, where the like data is associated with posts of each of the first set of users on the different social media platforms. In particular, the server 108 receives the like data of the first set of users from their verified accounts on the different social media platforms. Further, the server 108 analyses the like data and extracts popularity content from the like data. Based on the extracted popularity content, the server 108 further identifies a like based instruction within the extracted popularity content. The server 108 determines a number of like based instructions to determine a popularity level of a user associated with one of the first set of user accounts. In an exemplary scenario where a celebrity (i.e., one of the first set of users) has accounts on multiple social media platforms, the server 108 receives like data from a plurality of remote servers (i.e., the plurality of remote data sources) of the social media platforms. The like data includes information of posts of the celebrity and a number of likes and comments on each post. The server 108 extracts a number of like based instructions based on the like data. For instance, the server 108 determines that a picture of the celebrity on Twitter has 1 million likes. In such a case, each like on the picture corresponds to a like based instructions and the 1 million likes correspond to a number of like based instructions. Accordingly, based on the like based instructions of each of the first set of user accounts, the server 108 determines the popularity level of each of the first set of user accounts.

After associating each of the first set of user accounts with a respective specific stock currency value, the specific stock currency value is controlled by the server 108 based on changes in the popularity level of a corresponding user of the first set of users. To that end, the server 108 periodically receives the like data corresponding to the first set of user accounts from the plurality of remote data sources. The server 108 dynamically extracts the like based instructions from the like data and compares a number of like based instructions with a plurality of threshold levels. Based on a result of the comparison, the server 108 adjusts the popularity level of each user account of the first set of user accounts. Further, the server 108 adjusts the celebrity stock currency value of the at least one celebrity stock currency of each of the first set of user accounts based on the adjusted popularity level corresponding to each respective user account of the first set of user accounts.

Further, the server 108 outputs the adjusted celebrity stock currency value of the at least one stock of each respective user account of the first set of user accounts. In some embodiments, the adjusted celebrity stock currency value of the at least one stock is displayed on a display screen on one or more user devices of the first set of user devices 102a, 102b, . . . 102n and the second set of user devices 104a, 104b, . . . 104n. Additionally or alternatively, the server 108 sends notifications to the one or more user devices of the first set of user devices 102a, 102b, . . . 102n and the second set of user devices 104a, 104b, . . . 104n, where the notification indicates the adjusted celebrity stock currency value of the at least one stock. In particular, the server 108 identifies one or more users of the plurality of users associated with the at least one stock with adjusted celebrity stock currency value, where the one or more users are sellers (e.g., a celebrity) of the at least one stock and buyers (e.g., a follower of the celebrity) of the at least stock.

FIG. 2 illustrates a block diagram 200 of the server 108 of the system 100, in accordance with some embodiments of the present disclosure. The server 108 (known as the celebrity stock currency investment and payment server) includes a processor 202, a memory storage device 204, an input/output (I/O) device 206, a network interface 208, a celebrity stock currency database 210, celebrity analyzer 212, and a celebrity stock currency valuation engine 214, which are coupled with each other via a bus 216.

The processor 202 preferably comprises suitable logic, circuitry, and interfaces to execute computer-executable instructions stored in the memory 204. In some embodiments, the processor 202 is embodied as one or more of various processing means such as a microprocessor, a controller, a digital signal processor (DSP), application specific system processor (ASSP), or various other processing circuitry including integrated circuits such as, for example, an application specific integrated circuit (ASIC), a field programmable gate array (FPGA), a microcontroller unit (MCU), a special-purpose computer chip, or the like. As such, in some embodiments, the processor 202 includes one or more processing cores programmed and configured to perform independently. A multi-core processor enables multiprocessing within a single physical package.

Additionally, or alternatively, the processor 202 includes one or more processors programmed to perform independent execution of instructions, pipelining and/or multithreading. Additionally, or alternatively, the processor 202 includes one or more processors capable of processing large volumes of data and operations to provide support for big data analysis. Alternatively, in other embodiment, the processor 202 is embodied as an executor of software instructions, and the instructions specifically configure the processor 202 to perform the algorithms and/or operations described herein when the instructions are executed.

The processor 202 preferably includes, among other things, a clock, an arithmetic logic unit (ALU), registers, buses and logic gates programmed to support operation of the processor 202. Additionally, the processor 202 is programmed to create a plurality of user accounts based on user information of a respective user of the plurality of users.

In some embodiments, the processor 202 transmits an account request to each of the plurality of user devices (i.e., the first set of user devices 102a, 102b, . . . 102n and the second set of user devices 104a, 104b, . . . 104n). The account request corresponds to a request to create a user account to at least one of purchase or sell the at least one stock. Further, the processor 202 receives acceptance information from the plurality of user devices based on the transmission of the account request. To that end, each of the plurality of users provide one or more user inputs via a respective user device, where the one or more inputs corresponds to the acceptance information. In other words, the acceptance information is preferably an acknowledgement to the received request from the server 108. In a preferred embodiment, the plurality of user devices transmits the user information corresponding to each respective user of the plurality of users to the server 108. Accordingly, the processor 202 creates each of the plurality of user accounts based on the received acceptance information and the user information.

Further, the processor 202 preferably categorizes the plurality of user accounts into the first set of user accounts and the second set of user accounts based on the user information of the plurality of users. The processor 202 is preferably programmed and configured to acquire data from the memory, the I/O interface, the celebrity stock currency database 210, and external data sources and process the acquired data to a plurality of stock investment based operations. The plurality of stock investment based operations preferably comprise, but not limited to, determining the popularity level of each of the first set of user accounts, adjusting the popularity level, and adjusting the stock currency value based on the adjusted popularity level. The processor 202 also outputs the adjusted stock currency value to a user device of a seller (i.e., a user device of the first set of user devices 102a, 102b, . . . 102n) of the celebrity stock and one or more user devices of one or more buyers (i.e., one or more user devices of the second set of user devices 104a, 104b, . . . 104n) of the celebrity stock.

The memory 204 preferably comprises suitable logic, circuitry, and interfaces to store user data, historical data (e.g., the like data of each of the first set of user accounts) and computer-executable instructions which are executed by the processor 202. The memory 204 can be non-transitory and can include, for example, one or more volatile and/or non-volatile memories. In other words, for example, the memory 204 is preferably an electronic storage device (for example, a computer readable storage medium) comprising gates programmed or configured to store data (for example, bits) that are retrievable by a machine (for example, a computing device like the processor 202). The memory 204 stores information, data, content, applications, instructions, or the like, for enabling the processor 202 to carry out various functions in accordance with an example embodiment of the present disclosure. The memory 204 stores the like data corresponding to each user of the first set of users received from the plurality of remote data sources. Further, the memory 204 buffers input data obtained from an input/output device 206 for processing by the processor 202.

The input/output (I/O) device 206 comprises suitable logic, circuitry, and interfaces to receive user inputs and output data based on a result of analysis of data by the processor 202. Examples of the I/O device include, but are not limited to, a mobile phone, a laptop, a computer, a tablet, a touch based display screen, a monitor, a display device, or any electronic device configured to receive, process, and output data.

The network interface 208 comprises suitable logic, circuitry, and interfaces to enable communication between the server 108 and external devices such as the first set of user devices 102a, 102b, . . . 102n and the second set of user devices 104a, 104b, . . . 104n, over the communication network 106. In some embodiments, the network interface 208 is a network interface card (NIC) which is a hardware component, typically a circuit board or chip, which is installed on a hardware of the server 108 so that the server 108 can connect to the communication network 106. Further, the network interface 208 also provides functionalities to the server 108, such as support for I/O interrupt, direct memory access (DMA) interfaces, data transmission, network traffic engineering and partitioning. The network interface 208 provides the server 108 with a dedicated, full-time connection to the communication network 106. It implements the physical layer circuitry necessary for communicating with a data link layer standard, such as Ethernet or Wi-Fi. Each card represents a device and can prepare, transmit and control the flow of data on the communication network 106.

The celebrity stock currency database 210 preferably comprises suitable logic, circuitry, and interfaces to store the celebrity stock currency values of each of the first set of user accounts over a period of time. Further, the stock currency database 210 also updates the celebrity stock currency value based on a change in the celebrity stock currency value in accordance with the change in the popularity of a respective user of the first set of users. The celebrity stock currency data 210 is preferably a relational database or a non-relational database.

The celebrity analyzer 212 comprises suitable logic, circuitry, and interfaces to receive the like data of the first set of users from their verified accounts on the different social media platforms (i.e., the plurality of remote data sources), where the like data is associated with posts of each of the first set of users on their social media platforms. The like data is preferably obtained from various social media platforms such as YouTube, Instagram, Twitter, and the like.

The celebrity analyzer 212 analyzes the like data to determine popularity level of each of the first set of users. To that end, some embodiments are based on realization that the data (e.g., the like data) from different social media platforms is big and processing such data is time consuming as well as space consuming. Therefore, the celebrity analyzer 212 executes data analytics on the like data using techniques such as big data analytics which helps in analyzing big data in less time. The big data analytics describes a process of uncovering trends, patterns, and correlations in large amounts of raw data to help make data-informed decisions. These processes use statistical analysis techniques such clustering, regression, and the like. The celebrity analyzer 212 corresponds to one or more processors which are programmed and configured to execute the data analytics on the like data stored in the memory 204. Further, the celebrity analyzer 212 extracts popularity content from the like data based on the execution of the data analytics. The popularity content is associated with each of the first set of users of the first set of user accounts.

The popularity content preferably includes profile information of each of the first set of users, a number of likes on posts of each of the first set of users, a number of dislikes on the posts of each of the first set of users, a number of comments on the posts of each of the first set of users, content of the comments on the posts of each of the first set of users, and a number of shares of the posts of each of the first set of users, on accounts of each of the first set of users on different online platforms. The celebrity analyzer 212 extracts a like based instructions from the popularity content, where the like based instructions correspond to a like on a post of a user of the first set of users.

The celebrity analyzer 212 determines a number of likes on each post of each respective user of the first set of users and compares the number of likes with a specific threshold value. Based on a result of the comparison, the popularity level of a respective user of the first set of users is determined. Some embodiments are based on realization that the popularity of a celebrity changes with time. Accordingly, the server 108 periodically receives the like data from the plurality of remote data sources. As a result, the celebrity analyzer 212 periodically determines the popularity level of each of the first set of user accounts based on the like data.

The celebrity stock currency valuation engine 214 comprises suitable logic, circuitry (such as one or more processors), and interfaces to adjust the celebrity stock currency value of the at least one celebrity stock currency of each of the first set of user accounts, based on the adjusted popularity level corresponding to each respective user account of the first set of user accounts. To that end, the celebrity stock currency valuation engine 214 executes a comparison of like based data and authentication of the like data.

In a preferred embodiment, the celebrity stock currency valuation engine 214 authenticates each of the plurality of remote data sources from where the like data is obtained to authenticate the like data. Also, the celebrity stock valuation engine 214 controls authentication of the like data based on verification of accounts of people who likes the posts on social media platforms of each of the first set of users. After the authentication of the like data, the celebrity stock currency valuation engine 214 compares the like data with historical data stored in the memory 204. Based on the comparison, the celebrity stock currency valuation engine 214 determines a vector to adjust the celebrity stock currency. Based on the determined vector and the adjusted popularity level, the celebrity stock currency valuation engine 214 adjusts the celebrity stock currency value of each of the first set of user accounts.

In some embodiments, the processor 202 is further programmed to dynamically update the profile information associated with each of the first set of user accounts based on the adjusted popularity level of a respective user account of the first set of user accounts. The processor 202 is further programmed and configured to output, via the I/O device 206, the adjusted celebrity stock currency value of the at least one stock of each of the first set of user accounts and the updated profile information associated with each of the first set of user accounts.

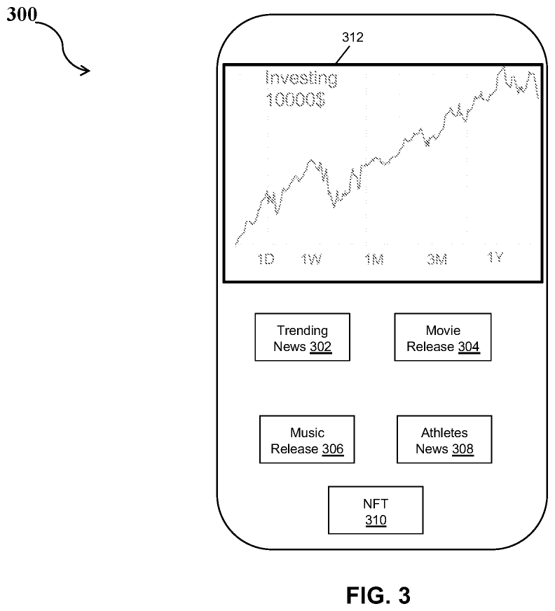

In some embodiments, the processor 202 is programmed and configured to output a plurality of user interfaces (UIs) on each user device of the first set of user devices 102a, 102b, . . . 102n and the second set of user devices 104a, 104b, . . . 104n. Each user of the plurality of users can provide input to the first plurality of UIs via their respective user device. FIG. 3 describes such UIs in detail.

FIG. 3 illustrates a first plurality of user interfaces (UIs) of an exemplary user device 300 of the system 100, in accordance with some embodiments of the present disclosure. The user device 300 preferably corresponds to each user device of the first set of user devices 102a, 102b, . . . 102n and the second set of user devices 104a, 104b, . . . 104n.

In some example embodiments, as shown in FIG. 3, the user device 300 displays the first plurality of UIs such as a plurality of icons 302-310 and a display window 312. Each icon of the plurality of icons 302-310 is customized in view of user details of the device 300. The user details preferably include information of a user account, where the user account indicates name of the user, at least one stock of the user, user as a seller or buyer of the at least one stock, and the like. The user can provide inputs to the icons 302-310. Accordingly, the display window 312 displays content associated with the plurality of icons 302-310 based on user inputs on the plurality of icons 302-310. In some cases, as shown in FIG. 3, the display window 312 displays trends as a stock growth curve of a stock of the user and an amount invested (e.g., $10,000) in a stock. Further, in the stock growth curve, values of the stock are preferably displayed over a period of time.

To generate the stock growth curve, the processor 202 is programmed and configured to generate temporal information associated with the stock value of the at least one stock of each of the first set of user accounts. The temporal information is generated based on a record of the stock value of the at least one stock with respect to time. Such record is preferably obtained from the celebrity stock currency database 210. Further, the processor 202 is programmed and configured to display the temporal information on a user interface (e.g., the display window 312) of the user device 300.

In some exemplary embodiments, the plurality of icons 302-310 include, but are not limited to, trending news 302, movie release 304, music release 306, athletes' news 308, Non-Fungible Token (NFT) 310, and the like. Each of the first set of users can upload their content on their respective account of the first set of user accounts on the server 108, where the content is preferably a trailer of their movies and/or songs, posts, announcements of upcoming projects or events, and the like. Preferably, the processor 202 categorizes the content in accordance with the plurality of icons 302-310 and output the icons 302-310 on the user device 300.

The trending news 302 is an icon that preferably includes news of the first set of users who are celebrities such as actors, a sportsperson, a politician, a social media personality having huge fan base, an aspiring artist, and the like. One or more of the second set of the users can access the news by providing one or more inputs to the icon. In response, the news is displayed in the display window 312. As a result, the one or more of the second set of users can decide whether to sell/buy the stocks.

The movie release 304 is an icon that includes data related to new movies of the first set of users who are celebrity actors or aspiring actors. Such may be useful for the second set of users to decide whether to purchase celebrity stocks associated with the celebrity actors or the aspiring actors.

The music release 306 is an icon that preferably includes data related to new music albums and songs of the first set of users who are celebrity musicians or aspiring musicians. Such data may be useful for the second set of users to decide whether to purchase celebrity stocks associated with the celebrity musicians or the aspiring musicians.

Some embodiments are based on a realization that a popularity of a person is impacted based on upcoming projects, new ventures, presence in media, and the like. Accordingly, in some embodiments, the server 108 collects information associated with plurality of user accounts from a plurality of remote data sources such a plurality of social media data servers and the like. The processor 202 adjusts popularity level one or more of the plurality of users based on the collected information. Additionally, the processor 202 adjusts the popularity level based on historical information of the one or more of the plurality of users, where the historical information is stored in the memory 204. Further, the processor 202 adjusts the celebrity stock currency value of the one or more of the plurality of users based on the adjusted popularity level of the one or more of the plurality of users.

The NFT 310 is an icon that is associated with selling/buying any form of art, a creative work, and the like in form of a non-fungible token (NFT). For instance, a painter who is one of the first set users sells their paintings in form of NFTs. A non-fungible token (NFT) is a unique cryptographic token that exists on a Blockchain and cannot be replicated. NFTs can be used to represent real-world items like artwork. “Tokenizing” these real-world tangible assets allows them to be bought, sold, and traded more efficiently while reducing the probability of fraud. Each user of the second set of users can purchase these NFTs.

Additionally, some embodiments are based on realization that a number of NFT's sold associated with each of the first set of users can impact the popularity corresponding to each of the first set of users. Accordingly, in some embodiments, the processor 202 adjusts a popularity level of a user based on a number of sold NFTs corresponding to the user. As a result, the processor 202 adjusts the celebrity stock currency value associated with user based on the adjusted popularity level.

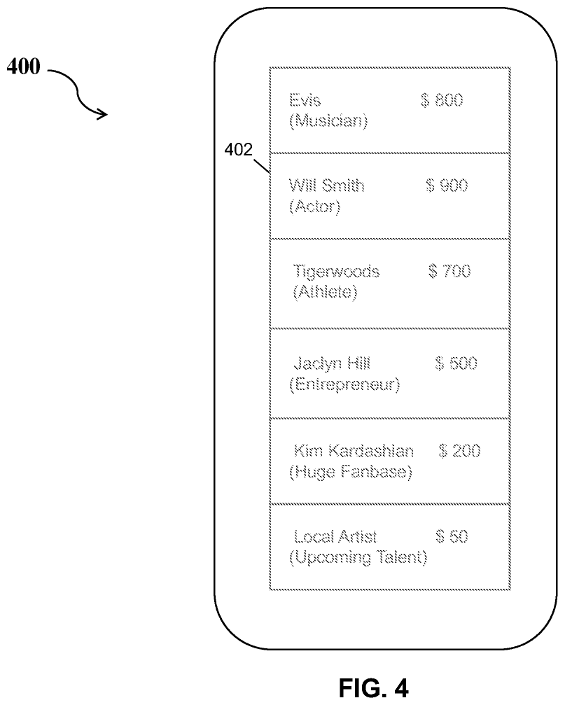

FIG. 4 illustrates a second plurality of user interfaces of the exemplary user device 400 of the system 100, in accordance with some embodiments of the present disclosure. The interface 402 is a graphical user interface. Graphical user interface (GUI) is a type of user interface through which users interact with electronic devices via visual indicator representations. In some embodiments, the processor 202 associates one or more stocks to each user account of the first set of user accounts. Each stock is associated with a stock value, which is a dynamic value. The processor 202 also controls each stock value based on determination of a popularity level.

In the GUI 402, the celebrity stock currency values of the first set of users who are celebrities, are displayed. For example, as shown in FIG. 4, the GUI 402 displays that Elvis is a musician and owns a celebrity stock currency value worth $800. Similarly, Will Smith who is a popular actor has a celebrity stock currency value worth $900. Tigerwoods is an athlete having a celebrity stock currency value worth $700. Jaclyn Hill is an entrepreneur having a celebrity stock currency value worth $500. Kim Kardashian is a popular social media personality having a huge fan base, owns a celebrity stock currency value worth $200. Similarly, a local artist who is an upcoming talent owns a celebrity stock currency value worth $50. In some embodiments, each user of the second set of users buys one or more stocks of at least one of the first set of users. To that end, each user of the second set of users purchases the one or more stocks via a respective user account of the second set of user accounts.

In some embodiments, each of the plurality of user accounts is associated with a payment interface that merges several banking features into a single platform of any participating bank and provides seamless fund routing, for example, a Unified Payment Interface (UPI). Examples of applications of such kind of payment interface preferably include, but are not limited to, PayPal, GooglePay, and the like.

Further, in some embodiments, at least one user of the second set of users logs into a respective user account of the second set of user accounts and provides a first user input via a first user interface (not shown) on the user device 400. The first user input corresponds to purchase of the at least one stock corresponding to at least one user account of the first set of user accounts. Accordingly, the processor 202 executes a plurality of transactions based on the reception of the first user input to purchase the one or more stocks of the first set of users who are celebrities having the first set of user accounts.

In a preferred embodiment, the processor 202 receives a second user input, via a second user interface (not shown), from at the least one user account of the first set of user accounts. The second user input corresponds to a permission (or acceptance) to the purchase of the at least one stock corresponding to the at least one user account of the first set of user accounts. The processor 202 preferably executes a plurality of transaction processes based on the reception of the second user input. The processor 202 further executes the plurality of transaction processes based on the reception of the second user input. Accordingly, the users can sell/buy celebrity stock with less processing time taken by the server 108.

In some embodiments, the processor 202 provides latest information of the one or more stocks bought by the second set of users. To that end, the processor 202 determines the first set of user accounts associated with the one or more stocks bought by a user of the second set of users. Further, the processor 202 outputs the latest values of the one or more stocks to each respective user account of the second set of user accounts. To output the latest values of one or more stocks, the processor 202 adjusts the value of the one or more stocks based on the adjusted popularity level of the first set of user accounts. Accordingly, the user stays updated with current trends of the desired stocks.

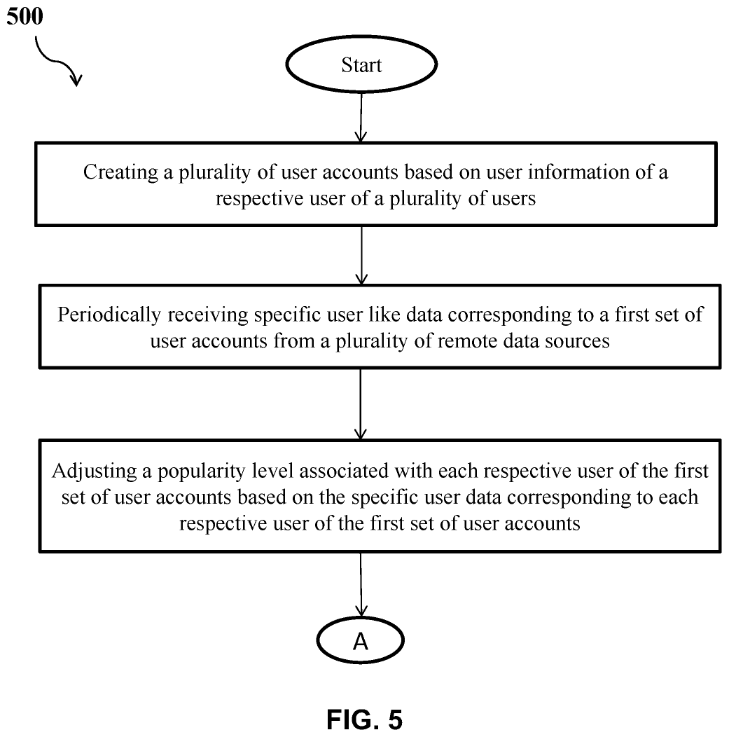

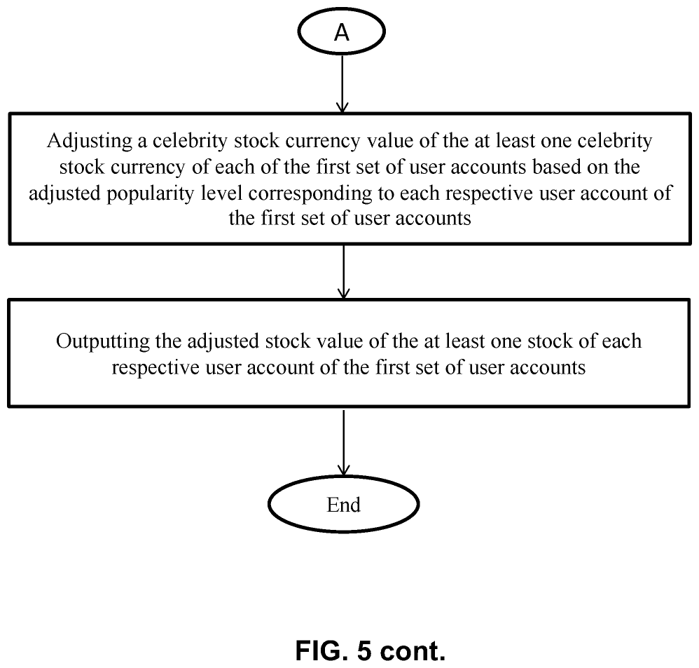

FIG. 5 illustrates a flow diagram of operations of the system 100, in accordance with some embodiments of the present disclosure. The operations start at step 502.

At step 502, a plurality of user accounts are created on a cloud server network device with one or more processors on a cloud communication network, wherein the plurality of user accounts are based on user information of a respective user of a plurality of users. The user information preferably includes name, email, phone number, age, and the like. A user can be a non-celebrity individual or a celebrity individual. Accordingly, the processor 202 preferably categorizes the plurality of user accounts into a first set of user accounts and a second set of user accounts.

In one embodiment, each of the first set of user accounts corresponds to a celebrity profile and each of the second set of user accounts corresponds to a non-celebrity profile. Each of the first set of user accounts of the plurality of user accounts has at least one stock, and each user account of the first set of user accounts is associated with a popularity level of each of a first set of users of the plurality of users. The server 108 determines the popularity level based on analysis of information of each user of the first set of users from a plurality of remote data sources.

In some additional embodiments, a first remote data source of the plurality of remote data sources is different from a second remote data source of the plurality of remote data sources. The plurality of remote data sources preferably includes social media sources such as YouTube, Instagram, Facebook, Twitter, and the like. In some embodiments, information of the plurality of remote data sources includes a number of followers of each user on social media platforms, like based instructions on posts of each user on the social media platforms, and the like.

At step 504, specific user data corresponding to the first set of user accounts is periodically received from the plurality of remote data sources. Some embodiments are based on realization that information of each user of the first set of users changes on regular basis. For instance, a celebrity uploads posts on daily basis on Twitter. As a result, popularity of each user keeps on changing. Accordingly, in some embodiments, the server 108 dynamically receives the specific user data of each of the first set of users from the plurality of remote data sources.

At step 506, the server 108 adjusts a popularity level associated with each respective user of the first set of user accounts. The server 108 preferably adjusts the popularity level based on the specific user data corresponding to each respective user of the first set of user accounts. The specific user data is received from plurality of remote data sources. In some embodiments, information of the plurality of remote data sources includes a number of followers of each user on different social media platforms, like based instructions on posts of each user on the social media platforms, and the like. The server 108 dynamically extracts the like based instructions and compares a number of like based instructions with a plurality of threshold levels. Based on a result of the comparison, the server 108 adjusts the popularity level of each user of the first set of users.

At step 508, the server 108 adjusts a celebrity stock currency value of the at least one celebrity stock currency of each of the first set of user accounts. Each user account of the first set of user accounts is associated with a celebrity stock currency. The server 108 adjusts a celebrity stock currency value of the at least one celebrity stock currency of each of the first set of user accounts, based on the adjusted popularity level corresponding to each respective user account of the first set of user accounts.

At step 510, the adjusted celebrity stock currency value of the at least one stock of each respective user account of the first set of user accounts, is output. Further, the server 108 outputs the adjusted celebrity stock currency value of the at least one stock of each respective user account of the first set of user accounts. In some embodiments, the adjusted celebrity stock currency value of the at least one stock is displayed on a display screen on one or more user devices (e.g., the user device 300 or the user device 400) of the first set of user devices 102a, 102b, . . . 102n and the second set of user devices 104a, 104b, . . . 104n.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process can be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments are constructed in which acts are performed in an order different than illustrated, which can include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

1. A system comprising a celebrity stock currency investment and payment server, said celebrity stock currency investment and payment server comprising:
a celebrity stock currency database;
a celebrity analyzer configured to receive like data from a plurality of user accounts, analyze the like data, extract popularity content from the like data, and identify a like based instruction within the extracted like data;
a celebrity stock currency valuation engine configured for like data based comparison and authentication;
a memory configured to store computer-executable instructions; and
at least one processor coupled to the celebrity stock currency database, the celebrity analyzer, and the celebrity stock currency valuation engine,
said at least one processor configured to execute the computer-executable instructions to:
create the plurality of user accounts based on user information of a respective user of the plurality of users, wherein each of a first set of user accounts of the plurality of user accounts has at least one stock, and
each user account of the first set of user accounts is associated with a popularity level of each of a first set of users of the plurality of users;
periodically receive specific user like data corresponding to the first set of user accounts from a plurality of remote data sources;
adjust the popularity level associated with each respective user of the first set of user accounts based on the specific user data corresponding to each respective user of the first set of user accounts;
adjust a celebrity stock currency value of the at least one celebrity stock currency of each of the first set of user accounts based on the adjusted popularity level corresponding to each respective user account of the first set of user accounts;
output the adjusted celebrity stock currency value of the at least one stock of each respective user account of the first set of user accounts and
a user device input interface comprising icons adapted for receipt of input of like data by the respective user of the first set of user accounts, wherein each user account of the first set of user accounts is associated with a payment interface adapted to provide seamless fund routing from at least a first bank institution to at least a second bank institution.

2. The system of claim 1, wherein the at least one processor is further configured to categorize the plurality of user accounts into the first set of user accounts and a second set of user accounts based on the user information of the plurality of users.

3. The system of claim 2, wherein the at least one processor is further configured to receive a first user input, via a first user interface, from at least one of the second set of user accounts of the plurality of user accounts, and the first user input corresponds to purchase of the at least one stock corresponding to at least one user account of the first set of user accounts.

4. The system of claim 3, wherein the at least one processor is further configured to execute a plurality of transaction processes based on the reception of the first user input.

5. The system of claim 3, wherein the at least one processor is further configured to:
receive a second user input, via a second user interface, from at the least one user account of the first set of user accounts, and
the second user input corresponds to a permission to the purchase of the at least one stock corresponding to the at least one user account of the first set of user accounts.

6. The system of claim 5, wherein the at least one processor is further configured to execute a plurality of transaction processes based on the reception of the second user input.

7. The system of claim 1, wherein a first remote data source of the plurality of remote data sources is different from a second remote data source of the plurality of remote data sources.

8. The system of claim 1, wherein the at least one processor is further configured to:
transmit an account request to each of a plurality of user devices of the plurality of users, wherein the account request corresponds to a request to create a user account to at least one of purchase or sell the at least one stock;
receive acceptance information from the plurality of user devices based on the transmission of the account request; and
create the plurality of user accounts based on the received acceptance information.

9. The system of claim 1, wherein the at least one processor is further configured to:
generate temporal information associated with the stock value of the at least one stock of each of the first set of user accounts, wherein the temporal information is generated based on a record of the stock value of the at least one stock with respect to time; and
control a display device to display the temporal information.

10. The system of claim 1, wherein
each of the first set of user accounts includes profile information associated with a respective user of the first set of users, and
the at least one processor is further configured to:
dynamically update the profile information associated with each of the first set of user accounts based on the adjusted popularity level of a respective user account of the first set of user accounts; and
control a display device to display the adjusted stock value of the at least one stock of each of the first set of user accounts and the updated profile information associated with each of the first set of user accounts.

11. A method for implementing a celebrity stock currency based investment and payment system, the method comprising:
creating a plurality of user accounts on a cloud server network device with one or more processors on a cloud communication network, said plurality of user accounts based on user information of a respective user of a plurality of users, wherein
each of a first set of user accounts of the plurality of user accounts has at least one stock, wherein each user account of the first set of user accounts is associated with a payment interface adapted to provide seamless fund routing from at least a first bank institution to at least a second bank institution, and
each user account of the first set of user accounts is associated with a popularity level of each of a first set of users of the plurality of users;
periodically receiving specific user like data input into a user device input interface comprising icons adapted for receipt of said specific user like data, said specific user like data corresponding to the first set of user accounts from a plurality of remote data sources;
adjusting the popularity level associated with each respective user of the first set of user accounts based on the specific user data corresponding to each respective user of the first set of user accounts;
adjusting a celebrity stock currency value of the at least one celebrity stock currency of each of the first set of user accounts based on the adjusted popularity level corresponding to each respective user account of the first set of user accounts; and
outputting the adjusted celebrity stock currency value of the at least one stock of each respective user account of the first set of user accounts.

12. The method of claim 11, further comprising categorizing the plurality of user accounts into the first set of user accounts and a second set of user accounts based on the user information of the plurality of users.

13. The method of claim 12, further comprising:
receiving a first user input, via a first user interface, from at least one of the second set of user accounts of the plurality of user accounts, wherein the first user input corresponds to purchase of the at least one stock corresponding to at least one user account of the first set of user accounts.

14. The method of claim 13, further comprising executing a plurality of transaction processes based on the reception of the first user input.

15. The method of claim 13, further comprising receiving a second user input, via a second user interface, from the at least one user account of the first set of user accounts, wherein the second user input corresponds to a permission to the purchase of the at least one stock corresponding to the at least one user account of the first set of user accounts.

16. The method of claim 15, further comprising executing a plurality of transaction processes based on the reception of the second user input.

17. The method of claim 11, wherein a first remote data source of the plurality of remote data sources is different from a second remote data source of the plurality of remote data sources.

18. The method of claim 11, further comprising:
transmitting an account request to each of a plurality of user devices of the plurality of users, wherein the account request corresponds to a request to create a user account to at least one of purchase or sell the at least one stock;
receiving acceptance information from the plurality of user devices based on the transmission of the account request; and
creating the plurality of user accounts based on the received acceptance information.

19. The method of clam 11, further comprising:
generating temporal information associated with the stock value of the at least one stock of each of the first set of user accounts, wherein the temporal information is generated based on a record of the stock value of the at least one stock with respect to time; and
controlling a display device to display the temporal information.

20. A non-transitory computer-readable medium having stored thereon computer-executable instructions which, when executed by a computer, cause the computer to execute operations, the operations comprising:
creating a plurality of user accounts based on user information of a respective user of a plurality of users, wherein
each of a first set of user accounts of the plurality of user accounts has at least one stock, wherein each user account of the first set of user accounts is associated with a payment interface adapted to provide seamless fund routing from at least a first bank institution to at least a second bank institution, and
each user account of the first set of user accounts is associated with a popularity level of each of a first set of users of the plurality of users;
periodically receiving specific user like data input into a user device input interface comprising icons adapted for receipt of said specific user like data from the respective user, said specific user like data corresponding to the first set of user accounts from a plurality of remote data sources;
adjusting the popularity level associated with each respective user of the first set of user accounts based on the specific user data corresponding to each respective user of the first set of user accounts;
adjusting a celebrity stock currency value of the at least one celebrity stock currency of each of the first set of user accounts based on the adjusted popularity level corresponding to each respective user account of the first set of user accounts; and
outputting the adjusted celebrity stock currency value of the at least one stock of each respective user account of the first set of user accounts.
